(19) United States
(12) Patent Application Publication
(10) Pub. No.: US 2021/0310808 A1
(43) Pub. Date: Oct. 7, 2021

(54) METHOD OF DISPLAYING COMPASS HEADINGS

(71) Applicant: Dien Mark Nguyen, Lighthouse Point, FL (US)

(72) Inventor: Dien Mark Nguyen, Lighthouse Point, FL (US)

(21) Appl. No.: 17/353,203

(22) Filed: Jun. 21, 2021

Related U.S. Application Data
(63) Continuation-in-part of application No. 15/868,817, filed on Jan. 11, 2018.

(51) Int. Cl. G01C 17/36; G08B 5/36

(52) U.S. Cl. CPC G01C 17/36; G08B 5/36

(57) ABSTRACT

A method of displaying compass headings includes the steps of: assigning specific colors to at least the four primary directional points North, East, South and West of a compass; and emitting the assigned colors from a single light source (e.g., a tri-colored LED) to visually indicate a current compass heading or orientation of a person, object, vehicle or craft (e.g., boat, airplane, helicopter or drone). The method may further include use of coded flashes of one or more colors to indicate compass points while minimizing the number of assigned colors for ease of memorization.

This non-provisional patent application is a Continuation-In-Part application of co-pending non-provisional patent application Ser. No. 15/868,817 filed Jan. 11, 2018.

### BACKGROUND OF THE INVENTION

### Field of the Invention

The invention relates to compass heading displays and, more particularly, to a method of displaying compass headings using a spectrum of colors.

### Description of the Related Art

The traditional magnetic compass has been the standard for use in navigation. A free-floating needle, disk, or sphere is used to display directional compass data. With the advent of the electronic compass, devices are more portable and accurate. Today's solid-state compass circuits are small and accurate. However, the graphic or alpha-numeric display contributes significantly to the cost, size, and complexity of the system. Assigning a dedicated LED to each of the compass points (N, S, E, and W) has also been considered, but this requires multiple LEDs (4, 8, or 16), increased size, and wiring complexity. It has also been proposed to use different light colors on a compass device for either ornamental purposes or to visually distinguish between the main compass points, namely North, East, South and West. U.S. Patent Application Publication No. 2017/0361132 to Dykes discloses a directional indicator for use on protective facemasks wherein multiple LEDs are used to illuminate a lens or cover that has directional indicators N, E, S, and W that are visible to the person wearing the facemask. The individual LEDs are each associated with one of the directional indicators and one of the LEDs illuminates at a time to brighten the associated directional indicator, and thereby indicate the direction of movement of the person wearing the facemask. Dykes also proposes to use various colors for the different directional indicators, however the colors are of no particular significance. More specifically, Dykes does not use light color as a source of information or as a means to convey directional indication strictly by the color. Rather, the multiple LEDs, whether white or of various colors, are simply used to illuminate the directional indicators N, E, S, and W on the cover of the device that is visible to the wearer of the facemask. U.S. Patent Application Publication No. 2014/0343843 to Yanku discloses a portable navigation prompt device that uses a plurality of LEDs as a prompt to alert the user of the device concerning various aspects of a selected route chosen by the user. For instance, various colored LEDs can prompt the user to continue forward, to turn left or to turn right. Yanku further discloses the use of multi-color LEDs (e.g., tri-color LEDs) for use to prompt the user to various aspects of the selected route, including the need to make a turn. The colors used in the device in Yanku are of no particular significance and are not used as a source of information alone. Yanku simply uses different colors to allow for multiple prompts that can be distinguished from one another. The particular color chosen for each prompt is of no particular significance. There is no teaching in the prior art of a method of using specific colors as a means to convey directional information, wherein different colors are specifically assigned to represent specific compass headings, thereby allowing the user to memorize the color assigned to each compass heading and instantly know the compass heading direction based on the color of the displayed light.

### SUMMARY OF THE INVENTION

The invention relates to a method of displaying compass directions/headings to an observer.

The method of the present invention includes the steps of: assigning specific colors to at least the four primary directional points North, East, South and West of a compass; and emitting the assigned colors from a single light source (e.g., a tri-colored LED) to visually indicate a current compass heading of a person, object, vehicle or craft (e.g., boat, airplane, helicopter or drone). The method may further include assigning specific colors to eight directional points of a compass, sixteen directional points of a compass, and so on. Moreover, the specific colors assigned to the four or more directional points of the compass may be according to a specific sequence, such as decreasing wavelength or the rainbow spectrum ROYGBIV (red, orange, yellow, green, blue, indigo and violet). The method may further include the step(s) of flashing the tri-colored (RGB) LED sequentially between adjacent colors to reduce the number of assigned colors, thereby allowing for easier memorization of assigned compass point colors by the user.

### BRIEF DESCRIPTION OF THE DRAWINGS

For a fuller understanding of the nature of the present invention, reference should be had to the following detailed description taken in connection with the accompanying drawings in which:

FIG. 1 is a schematic diagram showing a time domain graph, wherein each compass heading has four consecutive 100 mS flashes of the same or different light colors;

FIG. 2 is a top front perspective view of a waterproof multipurpose wearable light compass device in accordance with the present invention;

FIG. 3 is a top rear perspective view of the waterproof multipurpose wearable light compass device; and

FIG. 4 is a front perspective view showing a pair of swimming goggles with the waterproof multipurpose wearable light compass device of FIGS. 2-3 attached to the side band of the swimming goggles in a useful, operative position.

Like reference numerals refer to like parts throughout the several views of the drawings.

### DETAILED DESCRIPTION OF THE PREFERRED EMBODIMENTS

Definitions:
LED: Light Emitting Diode, a semiconductor photonic device that converts electrical currents to light.
RGB: Red, Green, Blue.
RGB LED: A single lens package device that physically contains a red, blue, and green LED that uses an additive color model to create all colors of the palette.

The method of the present invention uses colors as a means to convey directional information. More particularly, the method of the present invention provides for the assignment of an emitted colored light to represent each specific compass point. For example, 8 points of a compass (N, NE, E, SE, S, SW, W, NW) can be represented by 8 different color emissions, 16 points with 16 colors, and so on. Table 1 (below) provides the definition of each selected color to represent a compass heading. The user is required to memorize the colors assigned to each compass heading in Table 1 (referred to hereinafter as the “color table”) in order to immediately associate each color to a compass heading direction. This can be a disadvantage in the learning phase, but once memorized, the compass heading information can be quickly obtained from a glance.

Another intent of the present invention is to create a “standard” color palette to represent compass headings. A standard must be reproducible, so relevant variables must be defined. Using the commercially available LEDs, the reference wavelengths of each LED are as follows: red=625 nm, green=525 nm, and blue=465 nm. If other light sources are used with different wavelengths, then the intensity ratio of each of the RGB components must be adjusted accordingly in order to recreate the desired standard color.

One technique to help memorize the sequence is to use the decreasing wavelength or rainbow spectrum ROYGBIV (red, orange, yellow, green, blue, indigo, violet). In other words, the mapping of the visible color spectrum from longest to shortest wavelengths to represent the 360 degree compass points. This technique is designed to aid in the memorization of the color table. Just the simple knowledge of the rainbow color spectrum can quickly provide the user the heading of the four quadrants of the compass. As an example, if the assignment for N is red, then NE is orange, E is yellow, SE is yellow/green, S is green, SW is aqua/blue, W is indigo, NW is violet. With training, one can distinguish between the eight or maybe even 16 different colors. The accuracy or resolution of the system is limited by one's ability to differentiate between the adjacent colors. Another method to help reduce the memorization of many colors is to flash the LED sequentially between the adjacent colors. For example, for an 8-colored compass where N is red, NE is orange, and E is yellow, a certain system is designed to flash its directional color for one second on and one second off. When pointing N, the LED would flash red on for one second, then off for the next one second. The on/off flashing cycle of red (North) and off remains until the direction changes. Similarly for other colors/directions. To represent NNW, the LED would flash red for a half second, followed by a half second violet flash, then one second off; thus, sequential dual color flash. ENE would be orange for a half second, yellow for a half second, and then off for one second. The user now would only need to memorize 8 color positions while having codes to understand the 16 points of the compass.

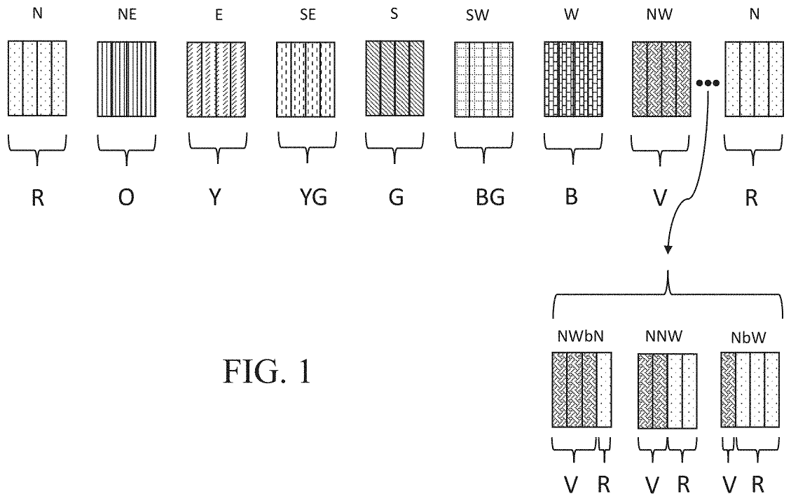

FIG. 1 shows a time domain graph, wherein each compass heading is defined by four consecutive 100 mS flashes. When the compass heading is north (N), the LED flashes red for 400 mS (4×100 ms) then turns off. When the heading is northwest (NW), the LED flashes violet for 400 mS, then turns off. But when the heading is exactly between N and NW or “NNW”, the LED will flash violet for 200 mS, followed by 200 mS of red. This method alone can provide 16 compass points of accuracy. Since this system uses four slots per color, there is an ability to increase the accuracy to 32 points of the compass. For example, northwest-by-north (NWbN) is represented by flashing violet for 300 mS followed by 100 ms of red, and north by west (NbW), violet for 100 mS followed by 300 mS of red.

TABLE 1
COMPASS COLOR DEFINITIONS

| HEADING | RGB LED Intensity Percentages | Visual Color* |
|---|---|---|
| NORTH | Red 100% (255/255), Green 0%, | Red |
| | Blue 0% | |
| NORTH EAST | Red 100% (255/255), Green 5% | Orange |
| | (13/255), Blue 0% | |
| EAST | Red 100% (255/255), Green 25% | Yellow |
| | (64/255), Blue 0% | |
| SOUTH EAST | Red 100% (255/255), Green 75% | Yellow-Green |
| | (140/255), Blue 0% | |
| SOUTH | Red 0%, Green 100% (255/255), | Green |
| | Blue 0% | |
| SOUTH WEST | Red 0%, Green 100% (255/255), | Blue-Green |
| | Blue 25% (64/255) | |
| WEST | Red 0%, Green20% (51/255), | Blue |
| | Blue 100% (255/255) | |
| NORTH WEST | Red 100% (255/255), Green 0%, | Violet |
| | Blue 50% (128/255) | |

*Visual Colors are the results of additive color mixing of the three internal RGB LEDs where red = 625 nm, green = 525 nm, and blue = 465 nm.

The assignment of 8 specific colors to the corresponding 8 points of the compass is demonstrated in Table 1. The 8 colors have been specifically designed for optimal visibility. The human eyes are least sensitive to the blue part of the light spectrum. Adding eye sensitive colors to the darker hues can increase the visibility of the light for distance sighting applications. For example, adding 20% intensity of primary green to the 100% primary blue brightens the color without changing our nomenclature for “blue”. According to the human eye cone sensitivity curves, our eyes are most sensitive to greens and reds. Thus, in designing the 8 directional colors, the green and red hues make up the majority of the 8 compass points. To precisely obtain the desired hue of each color, the circuit architecture uses 8-bit or 255 levels of intensity per primary color. The digital value of 0 (out of 255) equates to LED off, and 255 (out of 255) LED is on at 100% intensity.

For background purposes, a tri-colored LED is a single packaged LED which contains three individual primary colored LEDs (one red, one green, one blue). The intensity of each LED can be independently modulated and mixed to create (i.e., emit) any color our eyes see. With all colors at maximum intensity, the color will be white. For higher intensity applications, a number of individual RGB LEDs mounted closely on a panel can been used.

The application of the compass display method of the present invention can also be used to supplement the anti-collision or navigation light system used in aviation, marine, and off-road vehicles. This would allow a distant observer to see an incoming object's trajectory. This additional visual data can help to determine the path of the vehicle/object for collision avoidance. The compass colored light can be flashed or strobed at different rates to differentiate itself from existing navigation lights. For example, on a boat or plane, there are basically three navigation lights: red for left (port) side, green for right (starboard) side, and white for the stern or aft light. The colored compass light can be designed to replace or compliment the stern/aft light. In this instance, the RGB LEDs can be all-on (to represent white spectrum) as the white stern light. Perhaps every few seconds, the device would strobe in a specific color for the direction of travel of the vehicle/craft and then turn back to white. This will allow other pilots in the area to easily and quickly determine the direction of travel of another vehicle/craft.

The compass display method of the present invention can also be incorporated on helicopters, UAVs (unmanned aerial vehicle), or drones. Due to the omnidirectional nature of some drones, traditional aviation navigation lights (left, right, front, and aft) are not applicable. An RGB LED may be the optimal navigation light for drones due to its size and shape. Accelerometers and gyroscopes can be used in conjunction with the compass to signal the direction of travel instead of pointing direction.

The compass heading display method of the present invention can be applied to portable navigation devices. The simplistic display method can provide a significant cost, size, and reliability advantage. A product may have only an optical light window port while the active electronics of the compass can be fully sealed from the harsh environment, such as water and dust. The device's external-facing lens can transmit light to other locations by ways of reflective mirrors, fiber optics, acrylic light rod/pipe, optical gel/glue, or plexi-glass materials.

The directional compass display method of the present invention is ideal for swimming googles, scuba diving masks, virtual/augmented reality head-mounted displays, binoculars, smart-glasses, pens, pointers, and also vehicle dashboard displays. The compass colored light can be displayed as a point source from the LED lens or as background lighting. The optical display can be a part of the product casing itself, such as optically clear plexi-glass/plastic, or clear silicone rubber casing.

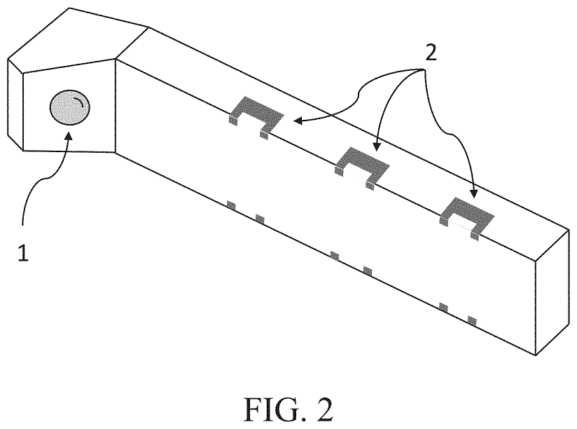

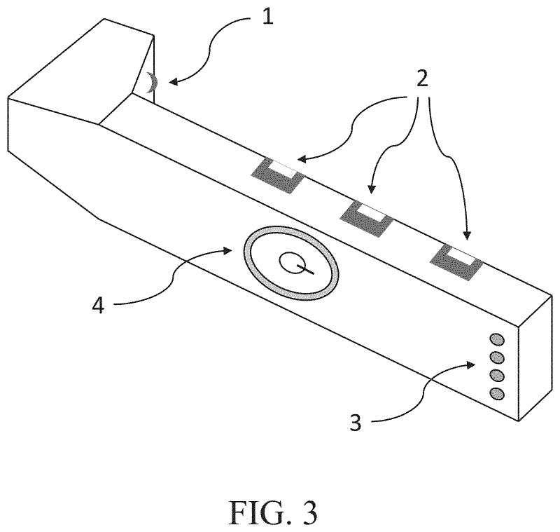

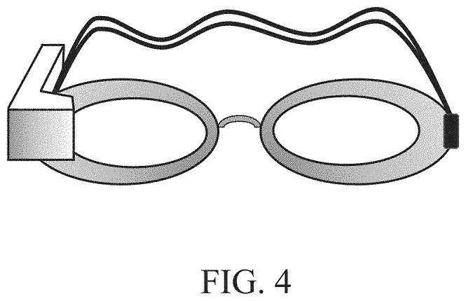

A waterproof multipurpose wearable light compass device is shown in FIG. 2 and FIG. 3. The device is a solid state electronic compass composed of a microprocessor, a tri-axis magnetic field sensor, a 6-axis accelerometer & gyroscope, and peripheral battery charging and RGB LED driver integrated circuits all contained in the housing of the device seen in FIGS. 2 and 3. The components listed in FIG. 2, FIG. 3 are list below. FIG. 4 shows a typical location for mounting the device of FIGS. 2 and 3 on a pair of swimming goggles. The device includes a single RGB LED display 1 that points back towards the user's peripheral vision. Mounting tabs 2 are provided to secure the compass to various items such as the side band of swimming goggles, scuba diving masks, sunglass temple arm, etc. The attachment is accomplished by using three string straps (not shown) across the compass overlapping the glass arms to secure the device. Conductive contact points 3 allow for compass charging and device programming. The device further includes a multifunction and On/Off button 4. Various sequence of button presses are used to accomplish various desired functions such as LED light output dimming, compass display refresh rates, calibration, and diagnostics.

The compass display method of the present invention can be employed in dashboard applications for any moving vehicles. It can help to de-clutter dashboard of graphics, texts, and numbers by using a glowing colored background to represent the direction of travel.

The directional compass display method of the present invention can also be incorporated in a standalone product such as a “compass puck,” a rounded product with a dome top for the optical LED and a sticky or magnetic bottom. The compass puck (or similar standalone device) would be a portable battery-powered electronic compass which you can mount anywhere to give you direction of travel or heading. Its useful applications are open to the creativity of the users. For example, placing several units of the compass puck at various locations on the deck of a sailboat will help the crew to confirm the captain's maneuvering intentions. It can also be mounted on off road vehicles, mountain bicycles, kayaks, etc.

Software and Firmware features of the directional compass, including the wearable compass, according to the method of the present invention are unique even though the hardware architectures are mostly common among portable electronic compasses. These software features are listed below.
A. Auto-off power saving feature where the device turns itself off if it doesn't detect compass point changes for a predetermined period. Saves battery when user stows away the unit without turning it off.
B. LED heading update frequency decreases when the heading direction remains constant over long period. When the user is on a constant heading during a long drive, the display will update less frequently to not disturb the user and to save power.
C. LED display is off while the user is in angular motion. LED display will only flash to the latest position after the movement has stopped. This is to prevent needless data transmission and also to save battery power.
D. Dimming features dynamically adjust the output pulse intensity using the mode/on/off button to prevent blinding the user in a low light environment.
E. Calibration mode allows the user to calibrate the device to any desired heading. For example, RED is usually set to magnetic north, but the user can re-calibrate the device's RED display to true north if desired.

While the present invention has been described in accordance with several preferred embodiments thereof, it is recognized that departures from the instant disclosure are fully contemplated within the spirit and scope of the present invention which is not to be limited except as defined in the following claims as interpreted under the Doctrine of Equivalents.

What is claimed is:

1. A method of displaying compass headings comprising the steps of:
assigning specific colors to directional points of a compass wherein the directional points are each assigned a different color; and
emitting the assigned colors from a single light source to visually indicate a current compass heading.

2. The method as recited in claim 1 wherein the step of assigning specific colors to directional points of a compass further comprises the step of:
assigning specific colors to at least the four primary directional points North, East, South and West of a compass.

3. The method as recited in claim 1 wherein the step of assigning specific colors to directional points of a compass further comprises the step of:
assigning specific colors to at least eight directional points of a compass including North, Northeast, East, Southeast, South, Southwest, West and Northwest.

4. The method as recited in claim 1 wherein the step of assigning specific colors to directional points of a compass further includes the step of:
assigning the specific colors in sequence according to the color spectrum of red, orange, yellow, green, blue, indigo, and violet.

5. The method as recited in claim 1 further comprising the step of:
emitting coded flashes of one or more of the assigned colors from the single light source to indicate at least some of the directional points of the compass.

6. The method as recited in claim 1 wherein the single light source is a tri-colored LED.

7. A method of displaying compass headings comprising the steps of:
assigning specific colors to directional points of a compass wherein the directional points are each assigned a different color; and
emitting the assigned colors from a multi-colored single light source to visually indicate a current compass heading.

8. The method as recited in claim 7 wherein the step of assigning specific colors to directional points of a compass further includes the step of:
assigning the specific colors in sequence according to the color spectrum of red, orange, yellow, green, blue, indigo, and violet.

9. The method as recited in claim 7 further comprising the step of:
emitting coded flashes of one or more of the assigned colors from the multi-colored single light source to indicate at least some of the directional points of the compass.

10. The method as recited in claim 7 wherein the multi-colored single light source is a tri-colored LED.
